(19) United States
(12) Patent Application Publication
(10) Pub. No.: US 2025/0216644 A1
(43) Pub. Date: Jul. 3, 2025

(54) LENS UNIT

(71) Applicant: Sharp Sensing Technology Corporation, Tenri City (JP)

(72) Inventors: SAE MANO, Tenri City (JP); Haruno Yoshida, Tenri City (JP); Fumio Torimatsu, Tenri City (JP); Masahiro Nakamura, Tenri City (JP); Yoshihito Ishizue, Tenri City (JP)

(21) Appl. No.: 18/979,989

(22) Filed: Dec. 13, 2024

(30) Foreign Application Priority Data
Dec. 27, 2023 (JP) 2023-220779

(51) Int. Cl. G02B 7/02

(52) U.S. Cl. CPC G02B 7/026

(57) ABSTRACT

A lens unit includes: a lens having an optical axis, a lens surface, and an outer circumferential surface; and a lens barrel having an inner circumferential surface and a seating face abutting a periphery of the lens surface, the lens barrel including a plurality of protrusions on the inner circumferential surface, the plurality of protrusions being separated from each other in an optical axis direction and from the seating face in the optical axis direction and abutting the outer circumferential surface.

### CROSS-REFERENCE TO RELATED APPLICATION

The present application claims priority from Japanese Application JP2023-220779, filed on Dec. 27, 2023, the content of which is hereby incorporated by reference into this application.

### BACKGROUND

### 1. Field

The present disclosure relates to lens units.

### 2. Description of the Related Art

Japanese Unexamined Patent Application Publication No. 2014-119707 discloses a lens unit. The lens unit has a gap between an inner circumferential surface of a tubular barrel of a lens holder and an outer circumferential surface of a first lens. The gap is provided in a portion that corresponds to approximately ⅔ of the thickness-wise dimension of the outer circumferential surface of the lens (paragraphs 0023 and 0031 and FIG. 1).

### SUMMARY

The lens unit disclosed in Japanese Unexamined Patent Application Publication No. 2014-119707 includes, in the portion where the gap is provided, no tilt prevention structure for the first lens. Therefore, the first lens can be easily tilted.

The present disclosure, in an aspect thereof, has been made in view of this problem. The present disclosure, in an aspect thereof, has an object to, for example, provide a lens unit that enables easily inserting a lens into a lens barrel and restraining the lens from tilting in the lens barrel.

The present disclosure, in an aspect thereof, is directed to a lens unit including: a lens having an optical axis, a lens surface, and an outer circumferential surface; and a lens barrel having an inner circumferential surface and a seating face abutting a periphery of the lens surface, the lens barrel including a plurality of protrusions on the inner circumferential surface, the plurality of protrusions being separated from each other in an optical axis direction and from the seating face in the optical axis direction and abutting the outer circumferential surface.

### BRIEF DESCRIPTION OF THE DRAWINGS

FIG. 1 is a schematic perspective view of a lens unit in accordance with Embodiment 1.

FIG. 2 is a schematic exploded perspective view of the lens unit in accordance with Embodiment 1.

FIG. 3 is a schematic cross-sectional perspective view of the lens unit in accordance with Embodiment 1 as it is dissected along a plane containing an optical axis.

FIG. 4 is a schematic vertical cross-sectional view of the lens unit in accordance with Embodiment 1 as it is dissected at the position of break line IV-IV shown in FIGS. 5 and 6.

FIG. 5 is a schematic horizontal cross-sectional view of the lens unit in accordance with Embodiment 1 as it is dissected at the position of break line V-V shown in FIG. 4.

FIG. 6 is a schematic horizontal cross-sectional view of the lens unit in accordance with Embodiment 1 as it is dissected at the position of break line VI-VI shown in FIG. 4.

FIG. 7 is a schematic cross-sectional perspective view of a lens unit in accordance with Embodiment 2 as it is dissected along a plane containing an optical axis.

FIG. 8 is a schematic vertical cross-sectional view of the lens unit in accordance with Embodiment 2.

FIG. 9 is a schematic cross-sectional perspective view of a lens unit in accordance with Embodiment 3 as it is dissected along a plane containing an optical axis.

FIG. 10 is a schematic vertical cross-sectional view of the lens unit in accordance with Embodiment 3 as it is dissected at the position of break line X-X shown in FIGS. 12, 13, and 14.

FIG. 11 is a schematic, enlarged vertical cross-sectional view of a part of the lens unit in accordance with Embodiment 3.

FIG. 12 is a schematic cross-sectional view of the lens unit in accordance with Embodiment 3 as it is dissected at the position of break line XII-XII shown in FIG. 10.

FIG. 13 is a schematic cross-sectional view of the lens unit in accordance with Embodiment 3 as it is dissected at the position of break line XIII-XIII shown in FIG. 10.

FIG. 14 is a schematic cross-sectional view of the lens unit in accordance with Embodiment 3 as it is dissected at the position of break line XIV-XIV shown in FIG. 10.

FIG. 15 is a schematic cross-sectional perspective view of a lens barrel in a lens unit in accordance with Embodiment 4 as it is dissected along a plane containing an optical axis.

FIG. 16 is a schematic horizontal cross-sectional view of the lens unit in accordance with Embodiment 4.

FIG. 17 is a schematic cross-sectional perspective view of a lens barrel in a lens unit in accordance with a variation example of Embodiment 4 as it is dissected along a plane containing an optical axis.

FIG. 18 is a schematic horizontal cross-sectional view of a lens unit in accordance with a variation example of Embodiment 4.

### DETAILED DESCRIPTION OF THE DISCLOSURE

The following will describe embodiments of the present disclosure with reference to drawings. Note that identical and equivalent elements in the drawings are denoted by the same reference numerals, and description thereof is not repeated.

### 1 Embodiment 1

### 1.1 Lens Unit

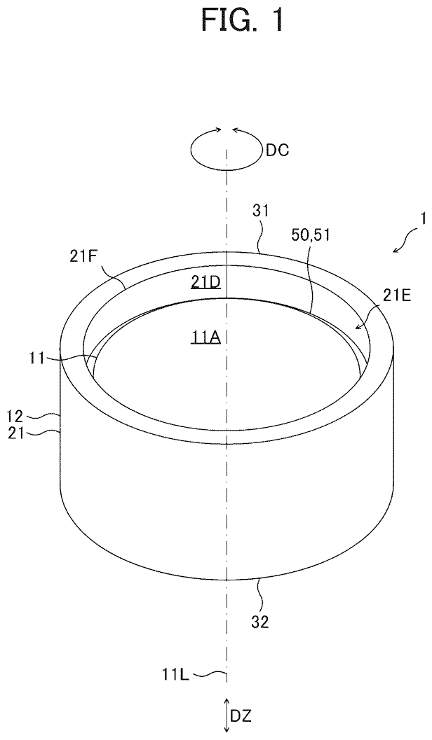

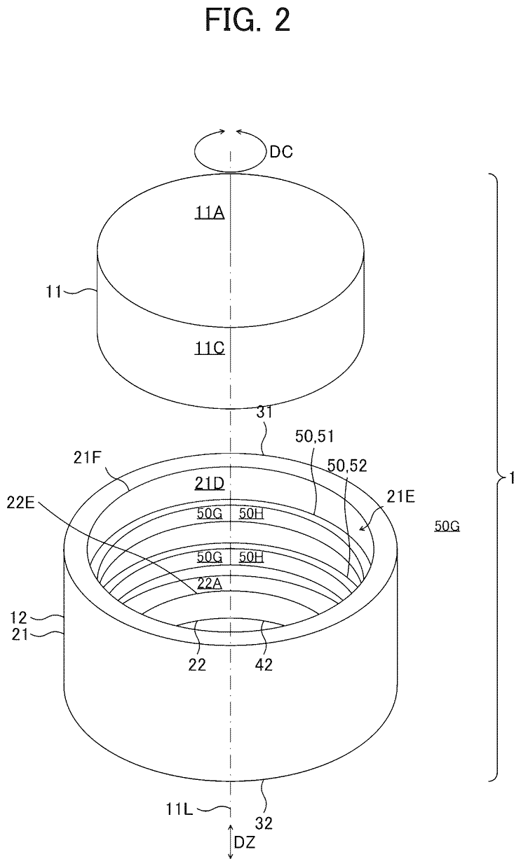

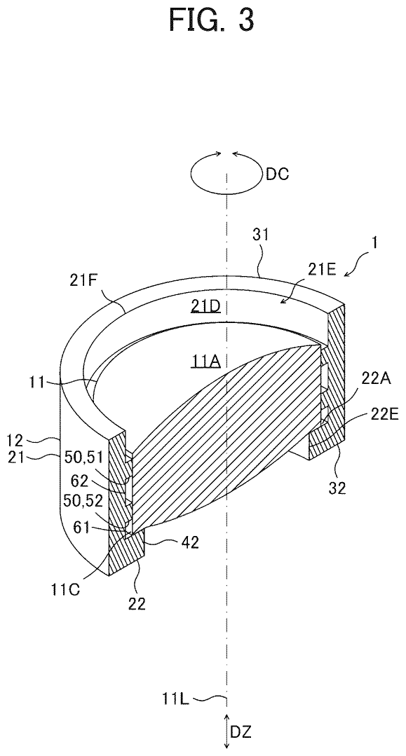

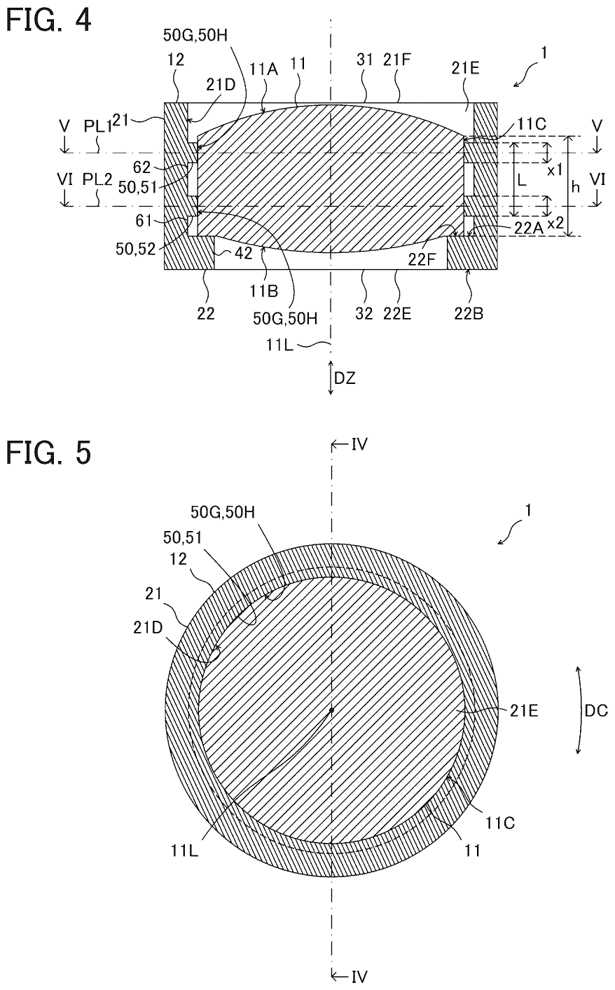

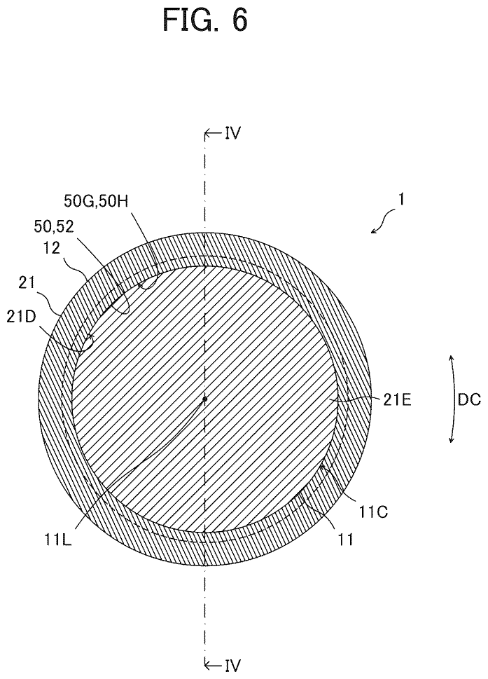

FIG. 1 is a schematic perspective view of a lens unit in accordance with Embodiment 1. FIG. 2 is a schematic exploded perspective view of the lens unit in accordance with Embodiment 1. FIG. 3 is a schematic cross-sectional perspective view of the lens unit in accordance with Embodiment 1 as it is dissected along a plane containing an optical axis. FIG. 4 is a schematic vertical cross-sectional view of the lens unit in accordance with Embodiment 1 as it is dissected at the position of break line IV-IV shown in FIGS. 5 and 6. FIG. 5 is a schematic horizontal cross-sectional view of the lens unit in accordance with Embodiment 1 as it is dissected at the position of break line V-V shown in FIG. 4. FIG. 6 is a schematic horizontal cross-sectional view of the lens unit in accordance with Embodiment 1 as it is dissected at the position of break line VI-VI shown in FIG. 4.

A lens unit 1 in accordance with Embodiment 1 shown in FIGS. 1 to 6 is included in a camera module. The lens unit 1 transmits the light to be received by an image sensor included in the camera module.

Referring to FIGS. 1 to 6, the lens unit 1 includes a lens 11 and a lens barrel 12.

The lens 11 transmits the light to be received by the image sensor.

The lens barrel 12 holds the lens 11.

The lens unit 1 includes an attaching medium (not shown). The attaching medium attaches the lens 11 to the lens barrel 12. Hence, the lens 11 is fixed to the lens barrel 12. The attaching medium is, for example, a cured product of an adhesive. The adhesive is, for example, a resin adhesive.

### 1.2 Lens

The lens 11 is a biconvex lens. The lens 11 may be a lens other than a biconvex lens.

The lens 11 has an optical axis 11L.

The lens 11 has a columnar shape. Therefore, the lens 11 has a first lens surface 11A, a second lens surface 11B, and an outer circumferential surface 11C. The first lens surface 11A and the second lens surface 11B are located opposite each other. The first lens surface 11A is a convexly curved surface. The second lens surface 11B is convexly curved in its central part. The second lens surface 11B is planar in its peripheral part. The outer circumferential surface 11C is a circumferential surface. The first lens surface 11A, the second lens surface 11B, and the outer circumferential surface 11C have a central axis that coincides with the optical axis 11L. The first lens surface 11A and the second lens surface 11B face a direction that intersects with the optical axis 11L. The outer circumferential surface 11C is parallel to the optical axis 11L.

### 1.3 Lens Barrel

Referring to FIGS. 1 to 6, the lens barrel 12 includes a first portion 21 and a second portion 22.

The first portion 21 is shaped like a hollow cylinder. Therefore, the first portion 21 has an inner circumferential surface 21D. The first portion 21 further has a first end portion 31 and a second end portion 32 as shown in FIGS. 1 to 4. The first portion 21 contains formed therein an empty space 21E delineated by the inner circumferential surface 21D. The inner circumferential surface 21D has a central axis that coincides with the optical axis 11L. The inner circumferential surface 21D is parallel to the optical axis 11L. The empty space 21E has a diameter greater than or equal to the diameter of the lens 11. The empty space 21E contains the lens 11. The empty space 21E has an insertion opening 21F. The insertion opening 21F is located on the first end portion 31. The lens 11 is inserted into the empty space 21E through the insertion opening 21F. The lens 11, when thus inserted, is moved in a direction that is parallel to an optical axis direction DZ and that runs from the first end portion 31 toward the second end portion 32.

The second portion 22 is shaped like a flat circular ring. Therefore, the second portion 22 has a first main face 22A and a second main face 22B. The first main face 22A and the second main face 22B are located opposite each other. The first main face 22A and the second main face 22B are planar. The first main face 22A and the second main face 22B have a central axis that coincides with the optical axis 11L. The first main face 22A and the second main face 22B are perpendicular to the optical axis 11L. The first main face 22A faces the empty space 21E in the first portion 21.

Referring to FIGS. 2 to 4, the second portion 22 includes an inner circumferential side end portion 42.

The second portion 22 extends radially inward from the second end portion 32. The second portion 22 has formed therein a circular hole 22E delineated by the inner circumferential side end portion 42. The circular hole 22E has a diameter shorter than the diameter of the lens 11.

Hence, referring to FIG. 4, the first main face 22A includes a seating face 22F that abuts the periphery of the second lens surface 11B. The seating face 22F abuts the lens 11 from the optical axis direction DZ. The seating face 22F fixes the position of the lens 11 relative to the optical axis direction DZ. The insertion opening 21F of the empty space 21E in the first portion 21 is located opposite the seating face 22F.

The lens barrel 12 can be manufactured with, for example, a three-dimensional (3D) printer.

### 1.4 Abutting of Lens Barrel to Lens at Plurality of Optical Axis Direction Positions

Referring to FIGS. 1 to 6, the inner circumferential surface 21D of the first portion 21 has formed thereon a plurality of protrusions 50. The plurality of protrusions 50 include two protrusions including a first protrusion 51 and a second protrusion 52. The plurality of protrusions 50 may include three or more protrusions.

Each protrusion 50 in the plurality of protrusions 50 is shaped like a circular ring. Each protrusion 50 protrudes radially inward. Each protrusion 50 is provided along the entire circumference of the lens barrel 12 in a circumferential direction DC.

Each protrusion 50 has an opposing surface 50G facing the outer circumferential surface 11C of the lens 11. The opposing surface 50G has an abutting face 50H radially inwardly abutting the outer circumferential surface 11C of the lens 11. The abutting face 50H fixes the radial position of the lens 11.

The opposing surface 50G of each protrusion 50 is a circumferential surface. The opposing surface 50G has a central axis that coincides with the optical axis 11L. The opposing surface 50G is parallel to the optical axis 11L. Each protrusion 50 has an inner diameter that matches with the diameter of the lens 11. Therefore, the abutting face 50H is the entire opposing surface 50G.

The plurality of protrusions 50 are separated from each other in the optical axis direction DZ. Hence, the plurality of abutting faces 50H of the plurality of protrusions 50 fix the position of the lens 11 at a plurality of optical axis direction positions respectively. Hence, the plurality of protrusions 50 restrain the lens 11 from tilting in the empty space 21E in the lens barrel 12.

The first protrusion 51 and the second protrusion 52 are provided respectively at a first optical axis direction position PL1 and a second optical axis direction position PL2 that divide the outer circumferential surface 11C of the lens 11 equally into three segments along the optical axis direction DZ.

The lens 11 becomes less likely to tilt in the empty space 21E in the lens barrel 12 with an increase in the distance L from the optical axis direction position, on the plurality of abutting faces 50H of the plurality of protrusions 50, that is the closest to the seating face 22F to the optical axis direction position thereof that is the closest to the insertion opening 21F. Therefore, the distance L is increased under the constraint that the distance L and the outer circumference thickness h of the lens 11 need to satisfy h≥L.

### 1.5 Refuse Produced When Lens is Inserted Into Lens Barrel

The lens 11 is inserted into the lens barrel 12 by, for example, press fitting or mating. When the lens 11 is inserted into the lens barrel 12 by, for example, press fitting or mating, it is difficult to insert the lens 11 into the lens barrel 12 while maintaining the complete alignment of the optical axis 11L of the lens 11 and the central axis of the lens barrel 12. Therefore, the outer circumferential surface 11C of the lens 11 and the abutting face 50H of the lens barrel 12 would scratch each other when the lens 11 is inserted into the lens barrel 12. Therefore, refuse could be produced by the substance exposed on the outer circumferential surface 11C of the lens 11 because the substance may fall off the outer circumferential surface 11C of the lens 11 when the lens 11 is inserted into the lens barrel 12. Refuse could be also produced by the substance exposed on the abutting face 50H of the lens barrel 12 because the substance may fall off the abutting face 50H of the lens barrel 12 when the lens 11 is inserted into the lens barrel 12. The substance that may fall off the outer circumferential surface 11C of the lens 11 is, for example, glass material and a reflection inhibitor for flare prevention. If a reflection inhibitor for flare prevention falls off the outer circumferential surface 11C of the lens 11, the flare prevention effect of the reflection inhibitor is compromised. Therefore, flares are more likely to occur in the lens unit 1.

1.6 Reducing Contact Area between Lens and Lens Barrel

The total length, x=x1+x2, of the plurality of abutting faces 50H of the plurality of protrusions 50 in the optical axis direction DZ is shorter than the outer circumference thickness h of the lens 11. Hence, the total length, x, of the plurality of abutting faces 50H in the optical axis direction DZ is shorter than the length h of the outer circumferential surface 11C of the lens 11 in the optical axis direction DZ. Hence, the abutting face 50H of the lens barrel 12 abuts only a part of the outer circumferential surface 11C of the lens 11.

If the abutting face 50H of the lens barrel 12 abuts the entire outer circumferential surface 11C of the lens 11, the contact area between the lens 11 and the lens barrel 12 grows larger.

That in turn increases the friction generated between the lens 11 and the lens barrel 12 when the lens 11 is inserted into the lens barrel 12. Therefore, the lens 11 cannot be readily inserted into the lens barrel 12. Therefore, the lens 11 is more likely to tilt in the empty space 21E in the lens barrel 12, and the optical axis direction DZ of the lens 11 is more likely to be displaced from the desirable position in the empty space 21E.

In addition, the above-described refuse is more likely to be produced. Therefore, the produced refuse is more likely to be trapped between the periphery of the second lens surface 11B of the lens 11 and the seating face 22F of the lens barrel 12. In addition, the produced refuse is more likely to be trapped between the outer circumferential surface 11C of the lens 11 and the abutting face 50H of the lens barrel 12. Therefore, the lens 11 is more likely to tilt in the empty space 21E in the lens barrel 12, and the optical axis direction DZ of the lens 11 is more likely to be displaced from the desirable position in the empty space 21E.

These disadvantages are particularly evident when the lens 11 is a lens with a large outer circumference thickness such as a front lens in a set of telephoto lenses.

On the other hand, if the abutting face 50H of the lens barrel 12 abuts only a part of the outer circumferential surface 11C of the lens 11, the contact area between the lens 11 and the lens barrel 12 decreases.

That in turn reduces the friction generated between the lens 11 and the lens barrel 12 when the lens 11 is inserted into the lens barrel 12. Therefore, the lens 11 can be readily inserted into the lens barrel 12. Therefore, the lens 11 is less likely to tilt in the empty space 21E in the lens barrel 12, and the optical axis direction DZ of the lens 11 is less likely to be displaced from the desirable position in the empty space 21E.

In addition, the above-described refuse is less likely to be produced. Therefore, the produced refuse is less likely to be trapped between the periphery of the second lens surface 11B of the lens 11 and the seating face 22F of the lens barrel 12. In addition, the produced refuse is less likely to be trapped between the outer circumferential surface 11C of the lens 11 and the abutting face 50H of the lens barrel 12. Therefore, the lens 11 is less likely to tilt in the empty space 21E in the lens barrel 12, and the optical axis direction DZ of the lens 11 is less likely to be displaced from the desirable position in the empty space 21E.

These advantages are particularly evident when the lens 11 is a lens with a large outer circumference thickness h, such as a front lens in a set of telephoto lenses. In particular, these advantages are particularly evident when the diameter D and the outer circumference thickness h of the lens 11 satisfy 0.15≤h/D.

If the plurality of protrusions 50 are n protrusions, where n is an integer greater than or equal to 2, the total length, x=x1+x2+x3+ . . . +xn, of the plurality of abutting faces 50H of the plurality of protrusions 50 in the optical axis direction DZ and the outer circumference thickness h of the lens 11 desirably satisfy 0.05≤x/h≤0.5. When the ratio x/h is below this range, it tends to be difficult for the plurality of protrusions 50 to fix the position of the lens 11. When the ratio x/h is above this range, it tends to be difficult to insert the lens 11 into the lens barrel 12.

### 1.7 Presence of Refuge for Refuse

The plurality of protrusions 50 are separated from the seating face 22F of the lens barrel 12 in the optical axis direction DZ. Therefore, referring to FIGS. 3 and 4, the second protrusion 52, disposed closest to the seating face 22F, faces the seating face 22F via a first gap 61 intervening between the outer circumferential surface 11C of the lens 11 and the inner circumferential surface 21D of the lens barrel 12.

The plurality of protrusions 50 are separated from each other in the optical axis direction DZ. Therefore, the first protrusion 51 and the second protrusion 52 are separated from each other in the optical axis direction DZ. Therefore, the first protrusion 51 and the second protrusion 52 face each other via a second gap 62 intervening between the outer circumferential surface 11C of the lens 11 and the inner circumferential surface 21D of the lens barrel 12.

The first gap 61 and the second gap 62 provide a refuge for the above-described refuse. Therefore, the presence of the first gap 61 and the second gap 62 renders the produced refuse less likely to be trapped between the periphery of the second lens surface 11B of the lens 11 and the seating face 22F of the lens barrel 12. In addition, the produced refuse is less likely to be trapped between the outer circumferential surface 11C of the lens 11 and the abutting face 50H of the lens barrel 12. Therefore, the lens 11 is less likely to tilt in the empty space 21E in the lens barrel 12, and the optical axis direction DZ of the lens 11 is less likely to be displaced from the desirable position in the empty space 21E.

### 2 Embodiment 2

The following description will focus on differences between Embodiment 2 and Embodiment 1. The description may be silent about the structures and features of Embodiment 2 that are the same as those of Embodiment 1.

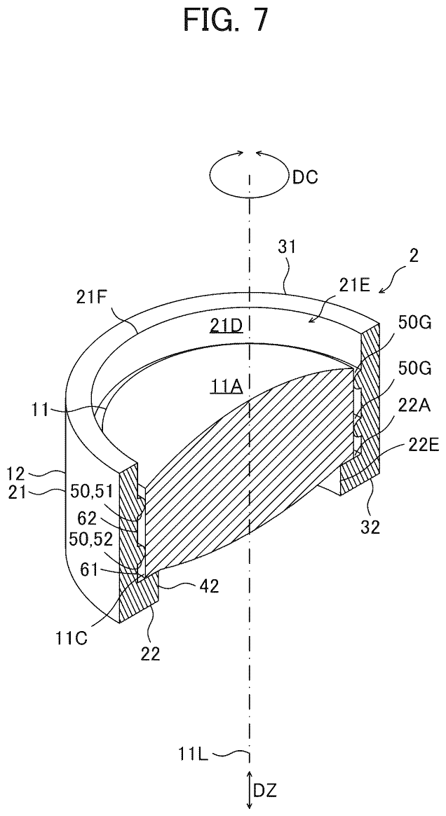

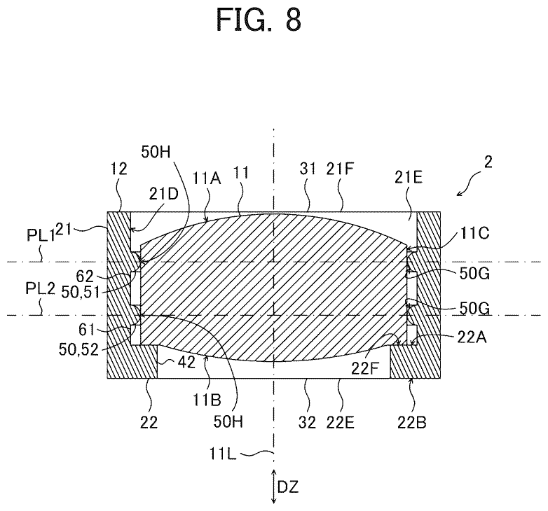

FIG. 7 is a schematic cross-sectional perspective view of a lens unit in accordance with Embodiment 2 as it is dissected along a plane containing an optical axis. FIG. 8 is a schematic vertical cross-sectional view of the lens unit in accordance with Embodiment 2.

In a lens unit 2 in accordance with Embodiment 2 shown in FIGS. 7 and 8, the opposing surface 50G of each protrusion 50 is convexly curved in the optical axis direction DZ. Therefore, the abutting face 50H of each protrusion 50 is a part of the opposing surface 50G. The abutting face 50H is located on the tip of the opposing surface 50G. This particular structure enables further reducing the contact area between the lens 11 and the lens barrel 12. This in turn enables more easily inserting the lens 11 into the lens barrel 12.

### 3 Embodiment 3

The following description will focus on differences between Embodiment 3 and Embodiment 1. The description may be silent about the structures and features of Embodiment 3 that are the same as those of Embodiment 1.

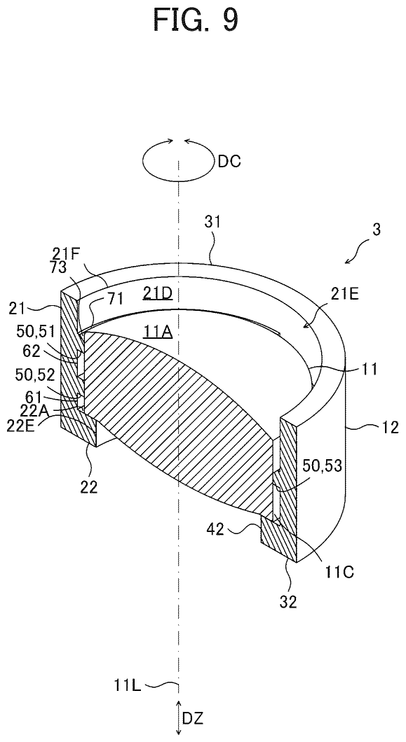

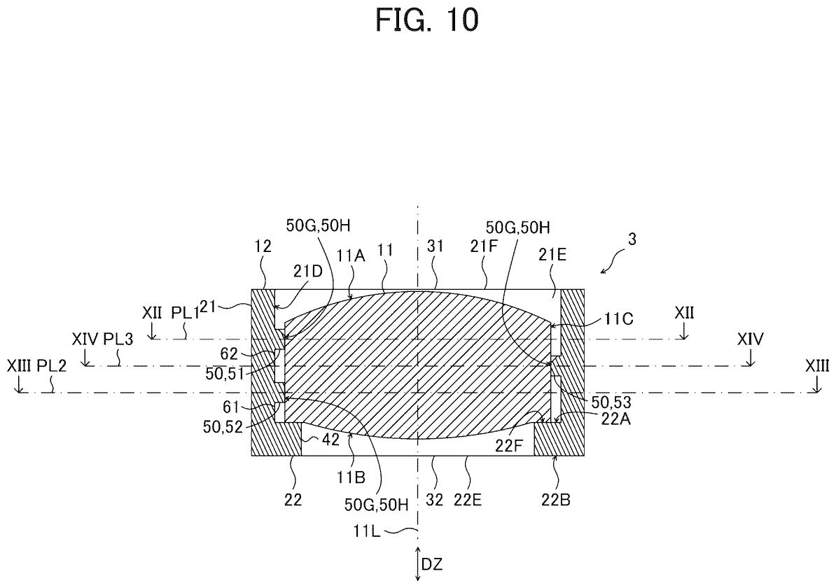

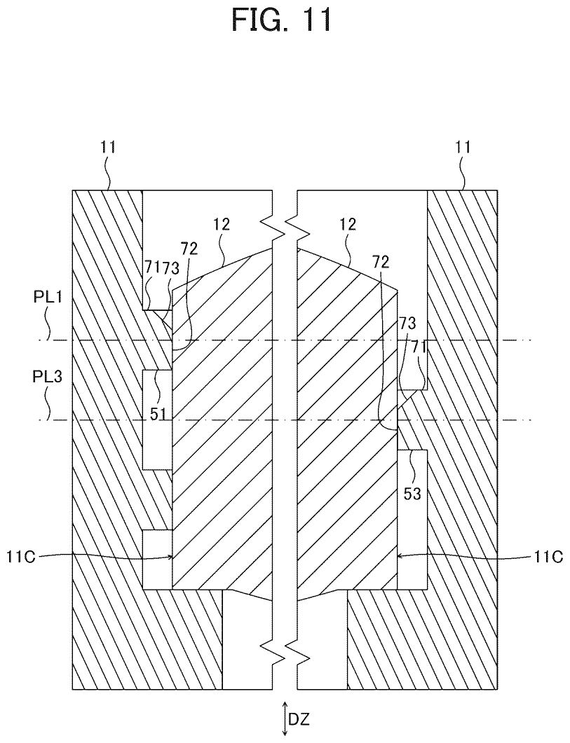

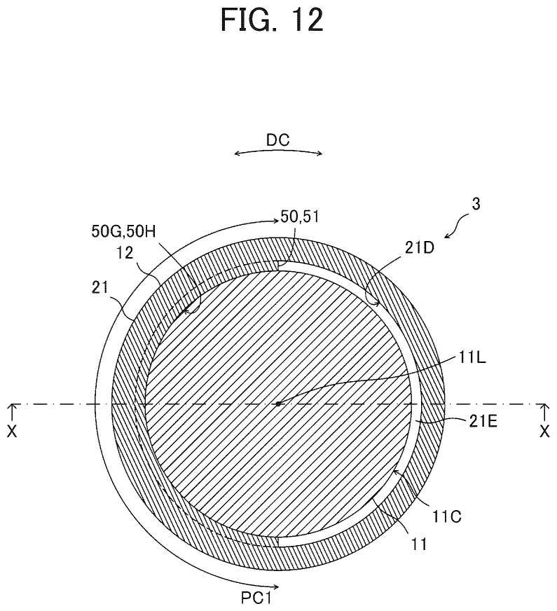

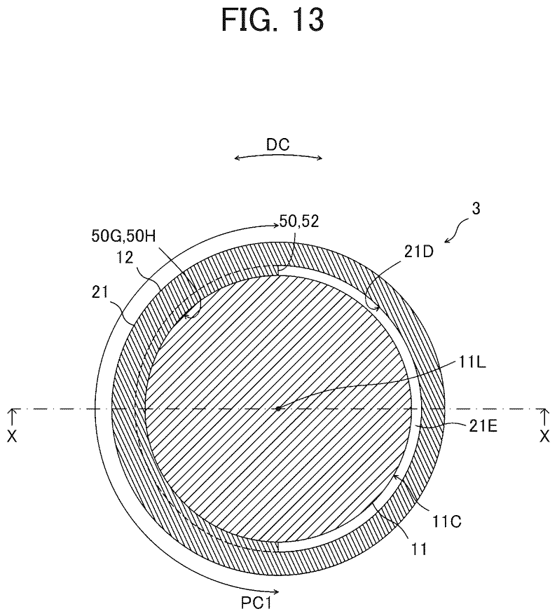

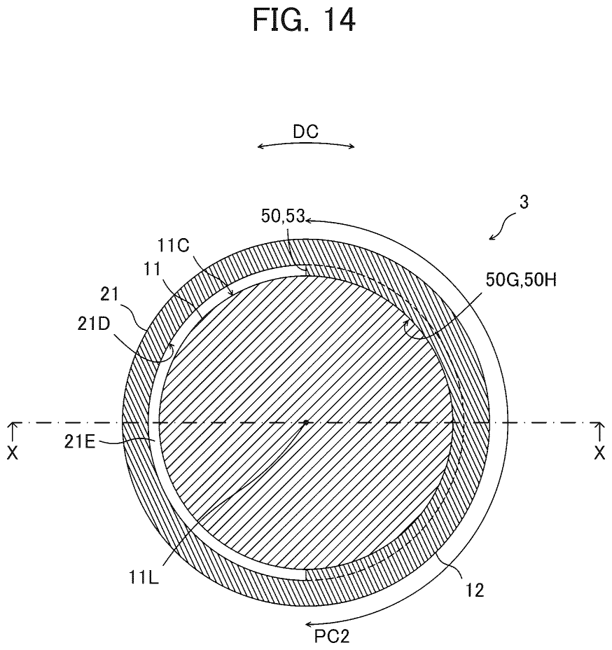

FIG. 9 is a schematic cross-sectional perspective view of a lens unit in accordance with Embodiment 3 as it is dissected along a plane containing an optical axis. FIG. 10 is a schematic vertical cross-sectional view of the lens unit in accordance with Embodiment 3 as it is dissected at the position of break line X-X shown in FIGS. 12, 13, and 14. FIG. 11 is a schematic, enlarged vertical cross-sectional view of a part of the lens unit in accordance with Embodiment 3. FIG. 12 is a schematic cross-sectional view of the lens unit in accordance with Embodiment 3 as it is dissected at the position of break line XII-XII shown in FIG. 10. FIG. 13 is a schematic cross-sectional view of the lens unit in accordance with Embodiment 3 as it is dissected at the position of break line XIII-XIII shown in FIG. 10. FIG. 14 is a schematic cross-sectional view of the lens unit in accordance with Embodiment 3 as it is dissected at the position of break line XIV-XIV shown in FIG. 10.

In a lens unit 3 in accordance with Embodiment 3 shown in FIGS. 9 to 14, the plurality of protrusions 50 include three protrusions of a first protrusion 51, a second protrusion 52, and a third protrusion 53.

Each protrusion 50 is provided along one half of the circumferential direction DC of the lens barrel 12.

The first protrusion 51 and the second protrusion 52 are provided in a first circumferential direction position PC1 in the circumferential direction of the lens barrel 12. The third protrusion 53 is provided in a second circumferential direction position PC2 in the circumferential direction DC of the lens barrel 12, the second circumferential direction position PC2 being offset from the first circumferential direction position PC1 by half the circumference.

The first protrusion 51 and the second protrusion 52 are provided respectively at the first optical axis direction position PL1 and the second optical axis direction position PL2 that are mutually different in the optical axis direction DZ. The third protrusion 53 is provided at a third optical axis direction position PL3 that sits between the first optical axis direction position PL1 and the second optical axis direction position PL2 in the optical axis direction DZ.

The first protrusion 51 and the second protrusion 52 respectively have a first abutting face 50H and a second abutting face 50H that abut the outer circumferential surface 11C of the lens 11 from one side. The third protrusion 53 has a third abutting face 50H that abuts the outer circumferential surface 11C of the lens 11 from another side.

That particular structure enables reducing the contact area between the lens 11 and the lens barrel 12 while restraining the lens 11 from tilting in the empty space 21E in the lens barrel 12. This in turn enables more easily inserting the lens 11 into the lens barrel 12 while restraining the lens 11 from tilting.

The length of the third abutting face 50H of the third protrusion 53 in the optical axis direction DZ may be equal to the length of each of the first abutting face 50H and the second abutting face 50H of the first protrusion 51 and the second protrusion 52 respectively in the optical axis direction DZ and may differ from the length of each of the first abutting face 50H and the second abutting face 50H in the optical axis direction DZ.

The first protrusion 51 and the third protrusion 53 are provided closest to the insertion opening 21F in the first circumferential direction position PC1 and the second circumferential direction position PC2 respectively. Therefore, the first protrusion 51 and the third protrusion 53 each face the insertion opening 21F of the empty space 21E in the lens barrel 12 with no other protrusion intervening therebetween.

Referring to FIG. 11, the first protrusion 51 and the third protrusion 53 each have a first face 71, a second face 72, and a C face 73.

The first face 71 is perpendicular to the optical axis direction DZ and faces the insertion opening 21F of the empty space 21E in the lens barrel 12. The second face 72 is parallel to the optical axis direction DZ and abuts the outer circumferential surface 11C of the lens 11. The C face 73 sits between the first face 71 and the second face 72. The C face 73 faces an intermediate direction between the direction that the first face 71 faces and the direction that the second face 72 faces.

Each of the first protrusion 51 and the third protrusion 53, which are provided closest to the insertion opening 21F in the first circumferential direction position PC1 and the second circumferential direction position PC2 respectively, has the C face 73. This particular structure will result in the passage of the lens 11 gradually narrowing down toward the seating face 22F of the lens barrel 12 at the first optical axis direction position PL1 and the third optical axis direction position PL3 when the lens 11 is inserted into the lens barrel 12. This in turn enables more easily inserting the lens 11 into the lens barrel 12 and also reduces the contact area between the lens 11 and the lens barrel 12.

### 4 Embodiment 4

The following description will focus on differences between Embodiment 4 and Embodiment 1. The description may be silent about the structures and features of Embodiment 4 that are the same as those of Embodiment 1.

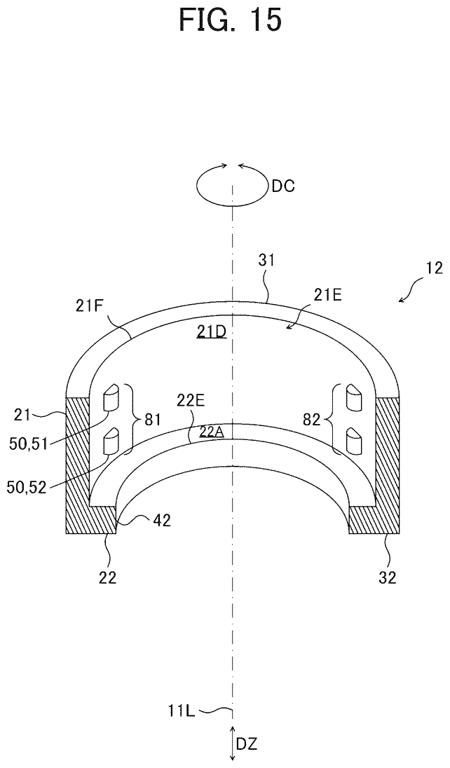

FIG. 15 is a schematic cross-sectional perspective view of a lens barrel in a lens unit in accordance with Embodiment 4 as it is dissected along a plane containing an optical axis. FIG. 16 is a schematic horizontal cross-sectional view of the lens unit in accordance with Embodiment 4.

In a lens barrel 12 in a lens unit 4 in accordance with Embodiment 4 shown in FIG. 15, there are provided three protrusion groups of a first protrusion group 81, a second protrusion group 82, and a third protrusion group 83 on an inner circumferential surface 21D of the lens barrel 12 as shown in FIGS. 15 and 16.

The first protrusion group 81, the second protrusion group 82, and the third protrusion group 83 are provided respectively at a first circumferential direction position PC11, a second circumferential direction position PC12, and a third circumferential direction position PC13 that are mutually different in a circumferential direction DC of the lens barrel 12.

The first circumferential direction position PC11, the second circumferential direction position PC12, and the third circumferential direction position PC13 divide the whole circumference of the lens barrel 12 in the circumferential direction DC equally into three segments.

Each protrusion group 80 among the first protrusion group 81, the second protrusion group 82, and the third protrusion group 83 includes a plurality of protrusions 50.

Each protrusion 50 is shaped like a hemicylinder with a central axis parallel to the optical axis direction DZ.

That particular structure reduces the contact area between the lens 11 and the lens barrel 12. This in turn enables more easily inserting the lens 11 into the lens barrel 12.

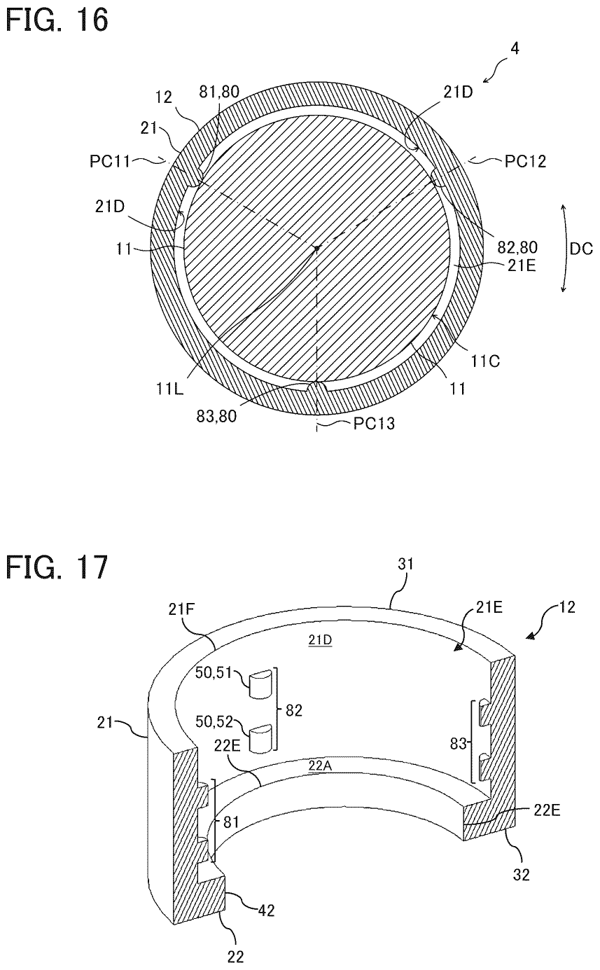

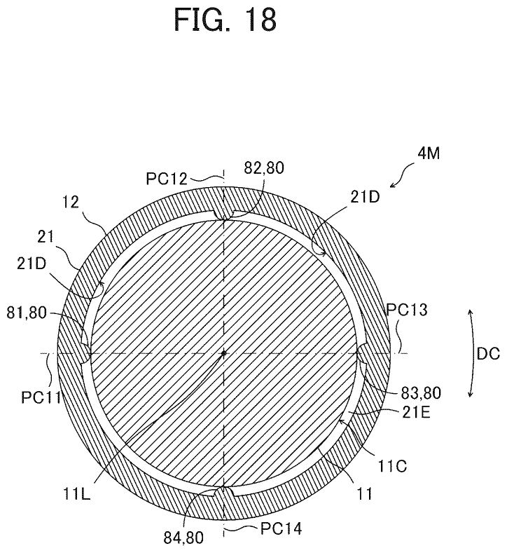

FIG. 17 is a schematic cross-sectional perspective view of a lens barrel in a lens unit in accordance with a variation example of Embodiment 4 as it is dissected along a plane containing an optical axis. FIG. 18 is a schematic horizontal cross-sectional view of a lens unit in accordance with a variation example of Embodiment 4.

In a lens barrel 12 in a lens unit 4M in accordance with a variation example of Embodiment 4 shown in FIG. 17, there are provided four protrusion groups of a first protrusion group 81, a second protrusion group 82, a third protrusion group 83, and a fourth protrusion group 84 on an inner circumferential surface 21D of the lens barrel 12 as shown in FIGS. 17 and 18.

The first protrusion group 81, the second protrusion group 82, the third protrusion group 83, and the fourth protrusion group 84 are provided respectively at a first circumferential direction position PC11, a second circumferential direction position PC12, a third circumferential direction position PC13, and a fourth circumferential direction position PC14 that are mutually different in a circumferential direction DC of the lens barrel 12.

The first circumferential direction position PC11, the second circumferential direction position PC12, the third circumferential direction position PC13, and the fourth circumferential direction position PC14 divide the whole circumference of the lens barrel 12 in the circumferential direction DC equally into four segments.

Each protrusion group 80 among the first protrusion group 81, the second protrusion group 82, the third protrusion group 83, and the fourth protrusion group 84 includes a plurality of protrusions 50.

There may be provided five or more protrusion groups on the inner circumferential surface 21D.

The present disclosure is not limited to the description of the embodiments and examples above. Any structure detailed in the embodiments and examples may be replaced by a practically identical structure, a structure that delivers practically the same effect and function, or a structure that achieves practically the same purpose.

What is claimed is:

1. A lens unit comprising:
a lens having an optical axis, a lens surface, and an outer circumferential surface; and
a lens barrel having an inner circumferential surface and a seating face abutting a periphery of the lens surface, the lens barrel including a plurality of protrusions on the inner circumferential surface, the plurality of protrusions being separated from each other in an optical axis direction and from the seating face in the optical axis direction and abutting the outer circumferential surface.

2. The lens unit according to claim 1, wherein each protrusion in the plurality of protrusions is provided along an entire circumference of the lens barrel in a circumferential direction of the lens barrel.

3. The lens unit according to claim 1, wherein the lens has a diameter D and an outer circumference thickness h such that 0.15≤h/D.

4. The lens unit according to claim 1, wherein
the plurality of protrusions respectively have a plurality of abutting faces abutting the outer circumferential surface, and
the plurality of abutting faces have a total length x in the optical axis direction and the lens has an outer circumference thickness h such that 0.05≤x/h≤0.5.

5. The lens unit according to claim 1, wherein the plurality of protrusions comprise two protrusions provided respectively at two optical axis direction positions by which the outer circumferential surface is divided equally into three segments in the optical axis direction.

6. The lens unit according to claim 1, wherein the plurality of protrusions comprise a protrusion facing the seating face via a gap intervening between the outer circumferential surface and the inner circumferential surface.

7. The lens unit according to claim 1, wherein the plurality of protrusions comprise two protrusions facing each other via a gap intervening between the outer circumferential surface and the inner circumferential surface.

8. The lens unit according to claim 1, wherein each protrusion in the plurality of protrusions has an opposing surface facing the outer circumferential surface and convexly curved in the optical axis direction.

9. The lens unit according to claim 1, wherein the plurality of protrusions comprise:
a first protrusion provided at a first circumferential direction position in a circumferential direction of the lens barrel and at a first optical axis direction position in the optical axis direction;
a second protrusion provided at the first circumferential direction position in the circumferential direction and at a second optical axis direction position in the optical axis direction, the second optical axis direction position differing from the first optical axis direction position; and
a third protrusion provided at a second circumferential direction position in the circumferential direction and at a third optical axis direction position in the optical axis direction, the second circumferential direction position differing from the first circumferential direction position, the third optical axis direction position being located between the first optical axis direction position and the second optical axis direction position.

10. The lens unit according to claim 1, wherein
the inner circumferential surface delineates an empty space containing the lens,
the empty space has an insertion opening opposite the seating face, and
the plurality of protrusions comprise a protrusion having a first face facing the insertion opening, a second face abutting the lens, and a C face between the first face and the second face.

11. The lens unit according to claim 1, further comprising three or more protrusion groups provided respectively at three or more circumferential direction positions on the inner circumferential surface, the three or more circumferential direction positions differing from each other in a circumferential direction of the lens barrel, wherein each of the three or more protrusion groups includes the plurality of protrusions.
